(19) United States
(12) Patent Application Publication
(10) Pub. No.: US 2015/0037780 A1
(43) Pub. Date: Feb. 5, 2015

(54) METHOD AND DEVICE FOR DETERMINING PERSONALITY AND MOOD

(71) Applicant: COSMETIC WARRIORS LIMITED, Poole Dorset (GB)

(72) Inventors: Mark Constantine, Poole Dorset (GB); Margaret Joan Constantine, Poole Dorset (GB); Helen Elizabeth Ambrosen, Wimborne Dorset (GB)

(21) Appl. No.: 14/372,611

(22) PCT Filed: Jan. 17, 2013
(86) PCT No.: PCT/GB2013/050100

§ 371 Date: Jul. 16, 2014

(30) Foreign Application Priority Data
Jan. 17, 2012 (GB) 1200779.5

(51) Int. Cl. G09B 3/06

(52) U.S. Cl. CPC G09B 3/06
USPC 434/350

(57) ABSTRACT

The invention relates to a method for determining the personality and current mood of a subject and to a device for carrying out the method and which may be used for selecting themes for use in a spa or beauty treatment. In the method and device themes or words describing mood or personality are each represented by a word and each word is associated with a colour.

The present invention relates to a method for determining the personality and mood of a subject and to a device for use in the method. The invention further relates to a spa treatment method in which the method and device are employed as well as to the use of the method and device for selecting cosmetic products for an individual. Specifically, the device and associated methods make use of the concept of association between words and colours.

Colour therapy has been used for centuries and was practised in ancient Egypt, China, Greece and India. Indeed colour is still at the heart of Ayurvedic medicine. Modern chromotherapy is linked to Ayurvedic medicine and is based on the theory that different parts of the body and different physical conditions are associated with different colours of light and involves exposing a patient to light of an appropriate colour. Coloured light can also affect the state of mind of a subject—for example yellow light can cause mental stimulation whereas pink light, may be useful for relaxation. Thus, for example chromotherapy may be used to help athletes to improve their performance since red light may be useful for sprinters or other athletes and sports people who need energy in short bursts whereas blue light is of use in treating competitors such as long distance runners who use energy over a longer period.

The method of the present invention, however, differs from chromotherapy in that it is based on the link between colours and words.

It is well known that there is a link between colours and words such that a particular word is commonly associated with a certain colour. Thus, if a group of people are asked to name a colour which they associate with a particular word, it is usual for a large majority of the group to choose the same or a similar colour. The effect may be culture dependent but within any given culture, the results appear to be remarkably consistent. For example, in the UK, the word “speed” is commonly associated with the colour red, “nature” with the colour green and “happiness” with yellow. There are numerous internet publications and websites relating to such associations, often in the context of interior or product design.

The present invention relates to an association between words and colours in the areas of spa and beauty type treatments and cosmetics, including the choice of cosmetic products for an individual. In order for these types of processes and treatments to be effective, it is necessary for them to be tailored to an individual client for whom the products are to be chosen or who is undergoing the treatment. Therefore, the present invention relates to a method of determining the personality and current mood of an individual client so that spa therapies and other treatments can be personalised for that client.

In order to personalise the spa or beauty treatment for each client, it is important to understand the personality and mood of the client. Clearly, the mood and emotional state of a person will vary from day to day so it is helpful for a spa or beauty therapist to have an understanding of the personality and mood of the client at the time when the treatment is to be carried out.

The type of spa or beauty treatment to which the method of present invention relates is based on one or more concepts. Concepts of this type include ideas such as “strengths and weaknesses”, “emotional needs”, “skills and talents”, “wishes”, “things that make you happy or sad”, “things that make you successful” etc.

Suitably, the method will be based on at least two and preferably at least three such concepts. In addition, when the method is based on two or three concepts, these may be linked. For example, the first concept may be “your intention” or “your strength or weakness”, the second may be “what you want or need” and the third may be “a skill or talent”, “a quality that is lacking” or “an aspiration”.

Each of the concepts is provided with a list of words. It is possible to use the same word list for all of the concepts used or, alternatively, a different list of words can be used for each concept. These words will generally be descriptive words which are descriptive of the personality or mood of a client and which can be used as themes for a spa or beauty treatment or for the selection of cosmetic products for a client.

Examples of words which may be linked with the types of concept useful in the present invention are ambition, beautiful, belief, calm, carefree, charisma, charm, cheerful, controlled, danger, daring, decisive, efficient, engaging, exciting, fantasy, glamorous, hard-working, optimistic, secure, shy, sophisticated, thoughtful and vibrant. Of course, these are only examples; there are many other suitable words which could be chosen.

The next step in the process is to provide a panel of people with both the one or more lists of words which are to be associated with the concepts and with a colour chart and to ask each member of the panel to select a colour for each of the words on the one or more lists. It has been found that a majority of the panel members will select the same or a similar colour for each of the words on the list or lists and therefore, at the end of the process it is possible to provide a plurality of colours on which the treatment is to be based and for each colour to be associated with one or more words which reflect the concepts on which the treatment is to be based.

In use, the client will select one or more colours on which they wish their treatment or their selection of products to be based and will then, as part of the treatment, be shown the words which are associated with those colours.

The selection of colours reflects the client's personality, mood and emotional state at the time when the selection is made and the association between the colours and the words enables the personality, mood and emotional state to be put into words, thus assisting the therapist in providing suitable spa or beauty therapy. The words may be used as themes within the spa or beauty treatment, for example themes for a treatment including meditation. Alternatively, they may be used as themes for the selection of cosmetic products appropriate to the client.

Therefore, in a first aspect of the present invention there is provided a method for determining personality and mood of a subject, the method comprising:
(i) supplying to a population sample a list of words and a set of colour samples;
(ii) requiring each member of the population sample to choose independently a colour from the set of colour samples to be associated with each word in the list;
(iii) identifying colours which are associated by at least 50% of the population sample with a word on the list;
(iv) displaying the identified colours to the subject, and requiring the subject to select one or more of the identified colours; and
(v) displaying to the subject the word from the list which is associated with each of the one or more selected colours;
   wherein the word or words displayed to the subject in step (v) are a reflection of the personality and the mood of the subject at the time of carrying out the method.

The method thus also provides the subject with words which help to elucidate and express their personality, mood and emotions.

With processes such as interior design or product design it is known to start with a word which reflects, for example, a desired mood or theme for a room or an image for a product and then to select a colour which is associated with that word. The idea behind the present invention differs from such known processes because in the present invention, the idea is for a client to select a colour and then be shown a word or group of words associated both with that colour and with a concept which forms the basis of a treatment which the client is to undergo or a selection of products for the client to use.

The inventors have carried out a selection process as described above where a group of people was provided with a list of words and a colour chart and each person was asked to select a colour for each of the words. For every one of the listed words, at least 50% of the group chose the same colour, though for certain words, the percentage was even higher than this. For example, over 70% of the sample selected a pink shade for the word “glamorous”, a deep vibrant pink for “passionate” a deep red for “power” and silver for “beautiful”. Over 60% of the group selected a vibrant red for “ambition”. For some words there was less consensus; for example words such as sophisticated, independent or inspired. However, even for these words at least 50% of the group chose the same colour.

Thus, a colour was considered to be associated with a word if it was chosen by more than 50% of the population sample.

In more suitable embodiments, a colour may be considered to be associated with a word if step (iii) above comprises identifying colours which are associated by at least 60% of the population with a word on the list.

Because of the association between the colours and the list of words, the user's choice of colour will reflect the user's personality as well as his or her mood, feelings, emotions and/or state of mind at the time the choice is made. Therefore the associated words will also reflect the user's personality, mood, feelings, emotions and state of mind. For this reason, the method of the invention is a valuable tool in a beauty or spa treatment as its use produces words which illustrate the personality, mood, feelings, emotions and state of mind of a user at the time when the treatment takes place. The words can be used as a part of the treatment, for example for meditation purposes. A specific example of a method for using the display device in a spa treatment is described in detail with reference to the specific embodiments. Alternatively, the device may be used in a retail outlet.

As mentioned above, the user's selection of colours represents his or her mood, feelings and emotions at the time when the choice is made. Therefore, if the exercise is repeated at a different time, user's mood, feelings, emotions and state of mind are likely to be different and therefore the choice of colours may also be different, as will the associated words.

The number of colours displayed to the subject may vary but will generally be from about 15 to 80, more usually about 20 to 70, often about 25 to 40 and typically 30 to 35.

Usually, each word will be associated with only one colour but in a few cases a single word may be associated with more than one colour. This may occur, for example if there is a wide variation in the choices provided by the population sample.

Also, in some cases, if there is one colour which is associated by the population sample with more than one, or in particular, with a large number of words, the second most popular colour may be chosen for a particular word.

The population sample preferably contains at least 5 individuals, for example 5-40 individuals, 5-15 or 5-10 individuals and more usually at least 10 individuals, for example 10-20 individuals In some cases, larger population samples will be used, for example groups containing 15-40, 20-40 or more than 40 individuals.

The colour samples provided to the population sample may contain more colours than the plurality of colours for selection by the user. For example, the number of colours provided to the population sample may be from about 15 to 100, more usually about 20 to 80, often about 25 to 60. The colour samples may be in any suitable format, for example a colour chart, colour cards or a Pantone™ book or chart.

The list of words will comprise the one or more lists of words associated with the concept on which the treatment or process is to be based as described above.

In one embodiment of the invention, in the method described above, step (v) is carried out after step (iv). However, in an alternative embodiment, steps (iv) and (v) may be carried out simultaneously.

In general, steps (i) to (iii) are carried out well in advance of steps (iv) and (v) and thus the method of the invention can alternatively be expressed as a method for determining personality and mood of a subject, the method comprising:
displaying a plurality of colours to the individual;
receiving from the individual a selection of a subset of colours from the plurality of colours; and
displaying, for each of the selected colours in the subset, a word associated with the selected colour;
   wherein the association of a word with a colour has been identified by means of:
(i) supplying to a population sample a list of words and a set of colour samples;
(ii) requiring each member of the population sample to choose independently a colour from the set of colour samples to be associated with each word in the list;
(iii) identifying colours which are associated by at least 50% of the population sample with a word on the list;
wherein the word or words displayed to the subject are a reflection of the personality and the mood of the subject at the time of carrying out the method.

In order to put this type of treatment into practice, it is necessary to provide a suitable way of displaying the colours and their associated words and this may be achieved using an appropriate display device.

Therefore, in a further aspect of the invention there is provided a display device for use in steps (iv) and (v) of the method of the invention.

Typically, the display device comprises:
means for displaying a plurality of colours for selection by a user; and
means for displaying one or more words associated with the selected colour;
wherein each colour is associated with one or more words and wherein the association of a word with a colour may be identified by means of:
(i) supplying to a population sample a list of words and a set of colour samples;
(ii) requiring each member of the population sample to choose independently a colour from the set of colour samples to be associated with each word in the list; and
(iii) identifying colours which are associated by at least 50% of the population sample with a word on the list.

The display device can be shown to a user who will select one or more colours. The device will display words associated with the selected colour. Particularly suitable features of steps (i), (ii) and (iii) are as for the method of the first aspect of the invention.

The number of colours displayed may vary but will generally be from about 15 to 80, more usually about 20 to 70, often about 25 to 40 and typically 30 to 35.

In one embodiment of the invention, the device has a single configuration in which the words and the colours are displayed simultaneously. However, for the purposes of the types of treatment in which the device is to be used, it is sometimes preferable for the words to be concealed until after the colours have been selected by the user. In this case the display device will suitably have a first configuration in which only the colours are displayed and a second configuration in which the word associated with a selected colour is displayed. In some cases, the second configuration will be such that all the colours and words are displayed simultaneously. In other cases, however, the second configuration will be such that only the words associated with colours which have been selected by the user will be displayed.

The display device may be any means of displaying colours and words which are associated with the colours. One example of such a display device is a chart on which the colours are displayed. In the single configuration embodiment, a word may simply be displayed on or next to the colour with which it is associated.

In the embodiment in which the words to be concealed until after the colours have been selected, the means for displaying a word associated with each colour may comprise a transparent film or sheet adapted to be positioned over the colour chart, and on which at or adjacent to the position of each colour of the chart the associated word is displayed. Thus, when the film is positioned over the chart, it is possible for a user to view both the colour and the associated word at the same time. In this embodiment, therefore, there is a first configuration in which only the colour chart is displayed and a second configuration in which the film is positioned over the colour chart so that a user can view both the colours and their associated words.

This type of chart may also be displayed on a computer screen with the computer being programmed either to display only the colours and words together (the single configuration embodiment) or the colours alone followed by the colours and words together. In the second configuration of this embodiment, the computer may either be programmed to display all the colours and words simultaneously or alternatively, only the words associated with colours which have been selected by the user will be displayed.

In another embodiment, the display device may comprise a set of rods, wherein all or part of each rod is coloured with a separate colour. On each rod the word associated with the colour of the rod is also printed. In this embodiment, the display device may also comprise a means for concealing the word. For example, the display device may comprise a container in which the rods may be placed and the words may be printed on the rods in such a position that they are concealed when the rods are positioned within the container. Once a colour has been chosen, the selected rod may be removed from the container so that the word is revealed. A container of this type may be a single compartment or, alternatively, it may comprise a plurality of separate compartments, typically one for each of the coloured rods. Alternatively, rods of this type may be provided with a sleeve or covering which conceals the word printed on the rod and which can be removed after a coloured rod has been selected to reveal the word.

Thus, in this embodiment of the invention, the first configuration comprises a set of coloured rods, wherein each rod is positioned in a container or is provided with a sleeve such that a word printed on the rod is concealed. In a second configuration, a rod of a selected colour is removed from the container or from the sleeve such that the word associated with the colour of the rod can be viewed.

In yet another embodiment, the means for displaying a plurality of colours may comprise a set of containers, wherein all or part of the outer surface of each container is of a separate colour. In the single configuration embodiment, the outer surface of the container may be labelled with the appropriate word. In the embodiment where the words are concealed until after the colours have been selected, the means for displaying the associated words may comprise the word associated with a particular colour being concealed within the appropriate container. The words may be printed on the inner surface of the container or, alternatively may be printed on a sheet of suitable material within the container. The sheet may be formed of any suitable material, for example paper, card, a plastics material or a fabric.

In one example of this embodiment, the containers may comprise separate drawers in a configuration of drawers. In this case, all or part of the visible surface of each drawer will be of a separate colour and a drawer of a chosen colour may be opened to reveal the word associated with that colour either printed on the inner surface of the drawer or on a sheet of an appropriate material contained within the drawer.

In another example of this embodiment, the containers may comprise cavities in a base, which may be, for example a block or wheel of an appropriate material, for example wood, metal or plastic. Each cavity may be covered with a lid of a separate colour and the associated word may be printed on the underside of the lid or inside the cavity or on a sheet of an appropriate material within the cavity.

It will be appreciated that many other types of display device can be envisaged which would fulfil the conditions of displaying colours and words associated with the colours.

As described above, the device is intended for determining personality and mood of a subject and is therefore of use in a spa or beauty treatment for selecting themes upon which the treatment is to be based and which reflect the personality and mood of the subject. The device can also be used for selecting cosmetic products for use in the treatment. Therefore, in a further aspect of the invention there is provided a method for selecting themes for use in a spa or beauty treatment for an individual comprising:
displaying a plurality of colours to the individual;
receiving from the individual a selection of a subset of colours from the plurality of colours; and
displaying, for each of the selected colours in the subset, a word associated with the selected colour;
   wherein the word represents a theme for the treatment; and
   wherein the association of a word with a colour has been identified by means of:
(i) supplying to a population sample a list of words and a set of colour samples;
(ii) requiring each member of the population sample to choose independently a colour from the set of colour samples to be associated with each word in the list; and
(iii) identifying colours which are associated by at least 50% of the population sample with a word on the list.

The spa or beauty treatment may be any kind of treatment which is given at a spa, beauty salon or similar. Examples include massage, aromatherapy, facials, make-up treatments, foot treatments, beauty treatments and holistic therapy treatments.

Suitable values for the number of colours displayed to the individual, the number of people in the population sample, the number of colours in the colour samples shown to the population sample and the way in which colours are selected for association with the words are as for the first aspect of the invention.

The device of the present invention may also be used as a means of selecting a tailored beauty package for use in a beauty or spa treatment or themed cosmetic products for use by an individual at home.

Therefore, in a further aspect of the invention there is provided a method of selecting a tailored beauty package and/or themed cosmetic products for an individual, comprising:
displaying a plurality of colours to the individual;
receiving from the individual a selection of a subset of colours from the plurality of colours; and
displaying, for each of the selected colours in the subset, a word associated with the selected colour;
   wherein the word represents a theme for the cosmetic products; and
   wherein the association of a word with a colour may be identified by means of:
(i) supplying to a population sample a list of words and a set of colour samples;
(ii) requiring each member of the population sample to choose independently a colour from the set of colour samples to be associated with each word in the list; and
(iii) identifying colours which are associated by at least 50% of the population sample with a word on the list.

Cosmetic products can be any product for application to the face, body or hair or bathing products and includes, for example facial products such as colours for skin, eyes or lips, face powder, moisturising or cleansing lotions or masks or face packs; products for the body such as moisturising or cleansing creams or lotions, body sprays; bathing products such as soaps, shower gels, bath foams, bath crystals and bath bombs; and hair products, for example shampoos, conditioners and hair colouring products.

This method is particularly suitable for use in a retail environment where a user will use the method to select products for use at home.

Typically, the method will be carried out using a display device according to the invention.

In one example of the use of such a device, the user will select one or more colours and will subsequently be assisted to use the device of the invention to find the associated word or words.

Suitable values for the number of colours displayed to the individual, the number of people in the population sample, the number of colours in the colour samples shown to the population sample and the way in which colours are selected for association with the words are as for the first aspect of the invention.

Since the display device of the invention can be used for selecting themed cosmetic products, there is also provided a cosmetic product, wherein the colour of the product is associated with a word and wherein the colour of the product may be selected by means of
(i) supplying to a population sample a list of words and a set of colour samples;
(ii) requiring each member of the population sample to choose independently a colour from the set of colour samples to be associated with each word in the list;
(iii) identifying colours which are associated by at least 50% of the population sample with a word on the list; and
(iv) selecting the identified colours.

The invention also provides a cosmetic product, wherein the name of the product is associated with its colour and wherein the colour of the product may be selected by means of:
supplying to a population sample a list of words representing product names and a set of colour samples;
(ii) requiring each member of the population sample to choose independently a colour from the set of colour samples to be associated with each word in the list; and
(iii) selecting colours which are associated by at least 50% of the population sample with a product name on the list.

Suitable values for the number of colours displayed to the individual, the number of people in the population sample, the number of colours in the colour samples shown to the population sample and the way in which colours are selected for association with the words are as for the first aspect of the invention.

Embodiments of the invention will now be described in greater detail by way of example only with reference to the drawings in which:

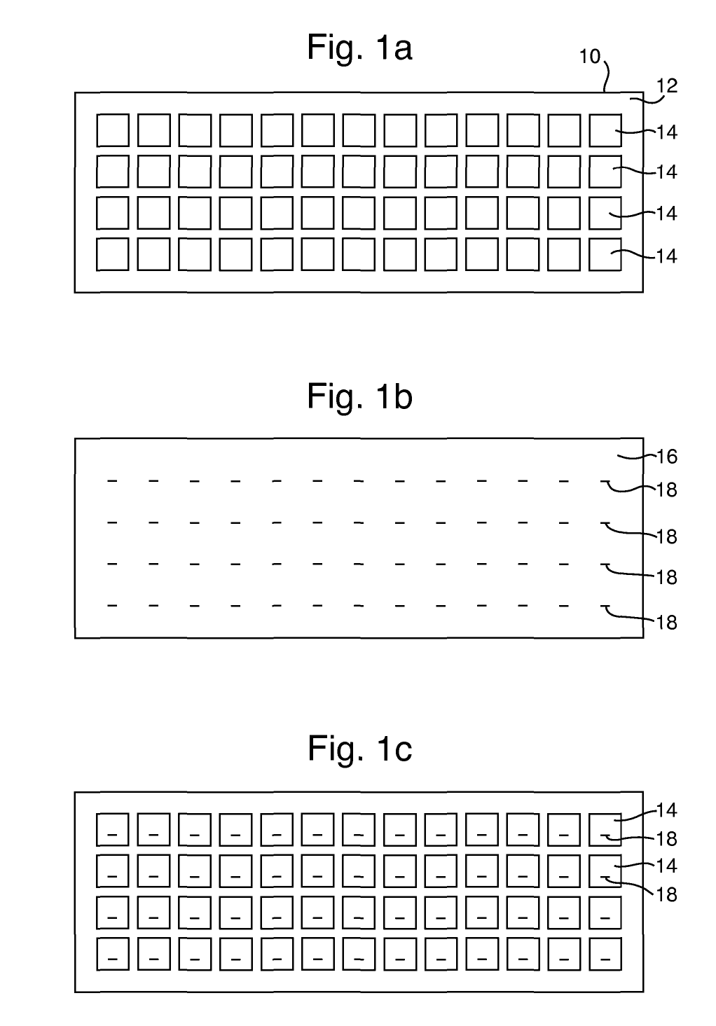

FIG. 1 shows a first embodiment of a device according to the invention;

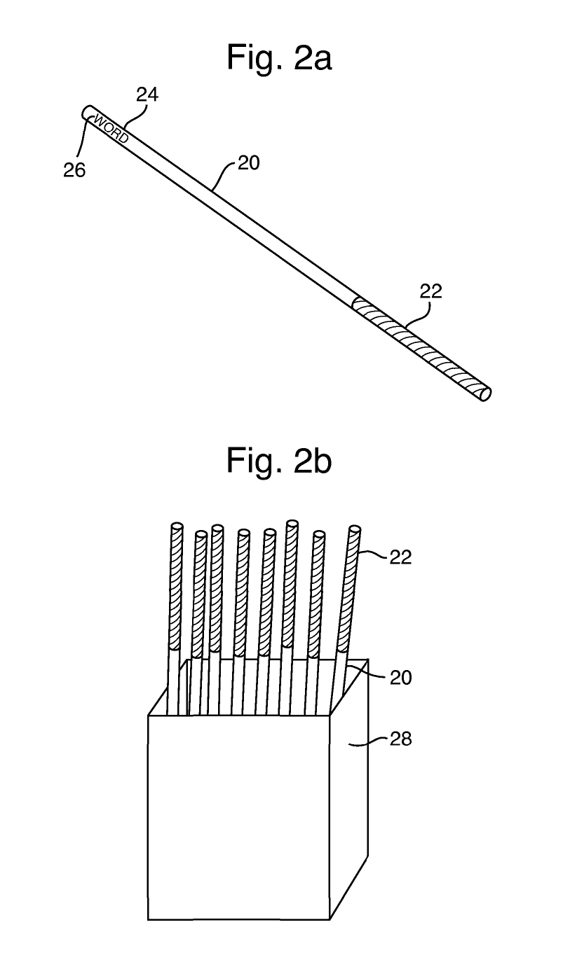

FIG. 2 shows an alternative embodiment of a device according to the invention;

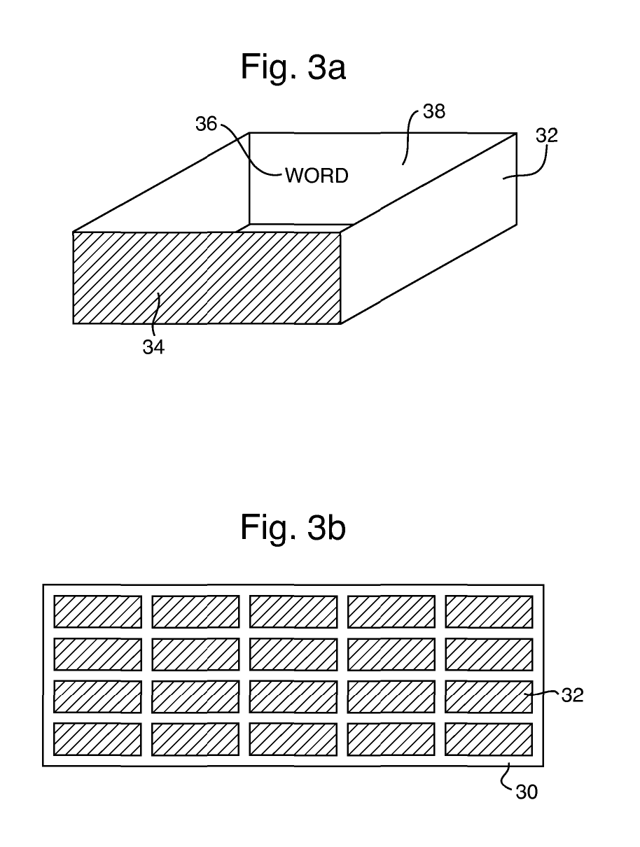

FIG. 3 shows a third embodiment of a device according to the invention; and

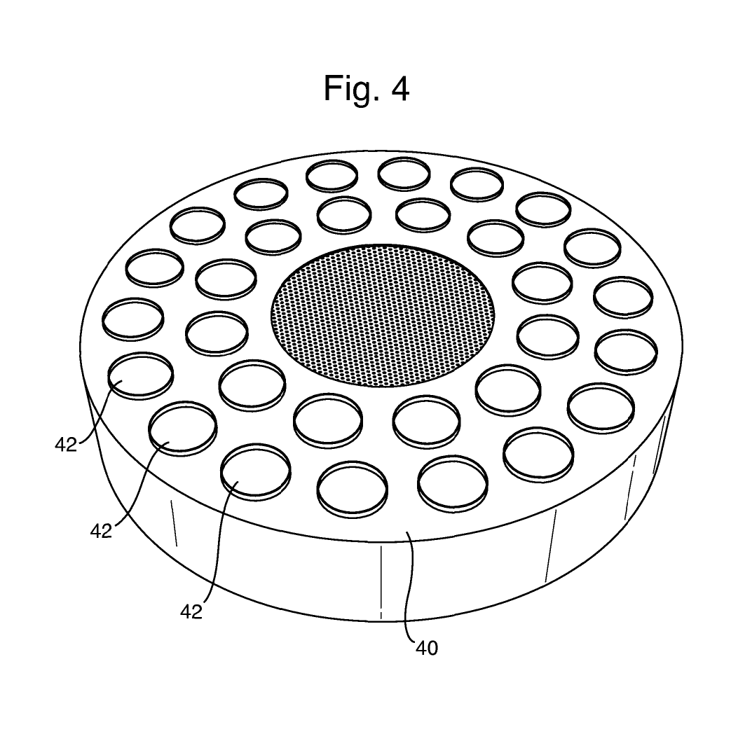

FIG. 4 shows a fourth embodiment of a device according to the invention.

FIG. 1a shows a display device comprising a colour chart 10, which consists of a flat base 12 on which are arranged a plurality of areas 14 of colour, with each area 14 being of a different colour. The base 12 may be made of any suitable material but will typically be formed form cardboard or a plastics material.

FIG. 1b shows a transparent film 16 which is adapted to be placed over the base 12 and on which are printed a series of words 18. Each of the words has been associated with a colour on the chart 10 by providing a panel of people with a list of words and a large selection of colours and asking each panel member to select an appropriate colour for each word. Each word in the list is then associated with the colour most frequently chosen by the panel members and the chosen colours are the colours which are used to make up the colour chart 10.

As shown in FIG. 1c, the words 18 are positioned on the film 16 so that when the film 16 is placed over the base 12, a word 18 appears in the centre of each of the areas 14 of colour. The colour on which the word 18 appears is the colour which was associated with that word by the members of the panel.

In other embodiments of the invention, however, the words 18 could be positioned such that when the film 16 is placed over the base 14, the words 18 appear above, below or to the side of the areas 14; the precise location of the words is not critical: it is simply necessary for a user to be able to associate a word with an area of colour.

In use, the colour chart 10 is shown to a user who is asked to select one or more of the colours shown in the areas 14. Once the colours have been selected, the film 16 is placed over the colour chart 10 so that, as shown in FIG. 1c, the words 18 and the coloured areas 14 can be viewed simultaneously. The user will thus be shown the words which are associated with the chosen colours. These words can then be used as the basis for a beauty or spa treatment or for the selection of cosmetic products either for use in a beauty or spa treatment or at the user's home.

For example, in one such spa therapy method, the user will be asked to choose first and optionally, second and/or third colours and will then be shown the words associated with the chosen colours.

In one embodiment, the first word can be interpreted as the user's intention at the moment of choosing the colour, their strength or weakness or perhaps an admirable quality they possess. The user may be told that the first colour can be worn to show the intention or quality expressed by the associated word.

The word associated with the second colour can be interpreted as the emotional need of the user at the time of choosing the colour and the user may be told that the colour can be worn to build on the intention or quality which is illustrated by the first colour.

The word associated with the third colour may be interpreted as an aspiration or a quality that is lacking but which could be built on and the colour may be worn to remind the user of this.

Further features of the spa therapy method may comprise meditating on the chosen colours and words and choosing products of the selected colours so that the user can “wear the chosen words”.

FIG. 2 shows an alternative embodiment of the invention in which the display device consists of a number of sticks or rods 20. As shown in FIG. 2a, each stick has a coloured portion 22 which represents one of the colour choices available to a user. Another area of the stick 24 has printed on it a word 26, which is associated with the colour shown on the portion 22. The association of the colours with the word list has been determined by members of a panel of people as described above in relation to FIG. 1.

As shown in FIG. 2b, there is also provided a container 28 into which a plurality of the sticks 20, each having a different colour in portion 22 can be placed such that the coloured portion 22 is visible while the area 24 on which the word 26 is printed is concealed within the container 28.

In use, the sticks 20, each of which has a different colour in the portion 22, are placed into the container 28 as shown in FIG. 2b and a user is asked to select one or more sticks according to the colour of the portions 22. Once the user has chosen the colours, the selected sticks 20 are removed from the container 28 and the user is shown the words 26 on the area 24 which are associated with the chosen colour. These words can then be used as the basis for a beauty or spa treatment or for the selection of cosmetic products either for use in a beauty or spa treatment or at the user's home.

The spa therapy method described above may also be used with this embodiment. However, in this embodiment, not all of the associated words are visible at one time and therefore, although all the colours may be chosen at once as described above, it is also possible to choose each colour separately and have the associated word displayed and explained before the next colour is chosen.

FIG. 3 shows yet another embodiment of the invention which, as shown in FIG. 3b, consists of a cabinet 30 containing drawers 32 where the visible face 34 of each drawer is of a different colour and represents one of a plurality of colour choices available to a user. A drawer 32 is shown in more detail in FIG. 3a. Inside the drawer 32 is printed a word 36 which is associated with the colour shown on the front face 34 of the drawer. The association of the colours on the drawers 32 with the words inside the drawers has been determined by members of a panel of people as described above in relation to FIG. 1.

The word 36 is not visible when the drawer is in the cabinet 30 and is in the closed position. In the embodiment shown in FIG. 3a, the word is printed on the back surface 38 of the drawer but this will not necessarily be the case. Indeed, the word could be printed on any of the inner surfaces of the drawer 32 provided that it is not visible when the drawer 32 is closed. Alternatively, a sheet of paper, plastic or card on which the word 36 is written could be provided inside the drawer 32 so that it could be removed when the drawer is opened.

In use, the drawers 32 are placed in the cabinet 30 and are pushed shut. A user is asked to select one or more drawers 32 on the basis of the colours shown on the front surfaces 34. Once the user has chosen the colours, the selected drawers are opened to reveal the word which is associated with the colour on the front of each chosen drawer. These words can then be used as the basis for a beauty or spa treatment or for the selection of cosmetic products either for use in a beauty or spa treatment or at the user's home.

The method described above may also be used with this embodiment. As with the device shown in FIG. 2 a user may choose all the colours at once and have the words displayed after choosing all of the colours or, alternatively, each colour may be chosen separately and the chosen word displayed and explained before the next colour is chosen.

FIG. 4 shows a further embodiment of the invention. The device of FIG. 4 consists of a block or wheel 40 which is constructed of wood, although other materials such as metal or plastic are also suitable. The wheel has a plurality of circular cavities each of which is covered by a circular lid 42. Each of the lids 42 is a different colour and represents one of a plurality of colour choices available to a user.

A word which is associated with the colour of a lid 42 is printed either on the underside of the lid or within the cavity covered by the lid 42. The word will therefore be displayed when the lid 42 is lifted.

In use, a user is asked to select one or more lids 42 on the basis of their colours. Optionally, before choosing the colours, the user may spin the wheel 40. Once the user has chosen the colours, the selected lids are opened to reveal the word which is associated with the colour of each lid. These words can then be used as the basis for a beauty or spa treatment or for the selection of cosmetic products either for use in a beauty or spa treatment or at the user's home.

The method described above may also be used with this embodiment. As with the devices shown in FIGS. 2 and 3, a user may choose all the colours at once and have the words displayed after choosing all of the colours or, alternatively, each colour may be chosen separately and the chosen word displayed and explained before the next colour is chosen.

In summary, the device and methods of the invention provide a means for determining the personality and mood of a subject and therefore for selecting individualised spa or beauty products or treatments which reflect both the personality of the user and his or her mood, feelings and emotions at the time when the selection is made.

The foregoing description has been given by way of example only and it will be appreciated by a person skilled in the art that modifications can be made without departing from the scope of the present invention.

1. A method for determining personality and mood of a subject, the method comprising:
(ii) supplying to a population sample a list of words and a set of colour samples;
(ii) requiring each member of the population sample to choose independently a colour from the set of colour samples to be associated with each word in the list;
(iii) identifying colours which are associated by at least 50% of the population sample with a word on the list;
(iv) displaying the identified colours to the subject, and requiring the subject to select one or more of the identified colours; and
(v) displaying to the subject the word from the list which is associated with each of the one or more selected colours;
wherein the word or words displayed to the subject in step (v) are a reflection of the personality and the mood of the subject at the time of carrying out the method.

2. A method according to claim 1, wherein the number of identified colours displayed to the subject is from about 15 to 80.

3. (canceled)

4. (canceled)

5. A method according to claim 1, wherein steps (iv) and (v) are carried out simultaneously.

6. A display device for carrying out steps (iv) and (v) of a method according to claim 1.

7. A display device according to claim 6 comprising:
a display of a plurality of colours for selection by a user; and
a display of one or more words associated with the selected colour;
wherein each colour is associated with one or more words and wherein the association of a word with a colour may be determined by:
(i) supplying to a population sample a list of words and a set of colour samples;
(ii) requiring each member of the population sample to choose independently a colour from the set of colour samples to be associated with each word in the list; and
(iii) identifying colours which are associated by at least 50% of the population sample with a word on the list.

8. A display device according to claim 5, wherein the number of colours displayed for selection is from about 15 to 80.

9. (canceled)

10. A display device according to claim 6, wherein the list of words supplied to the population sample comprises a list of words associated with concepts on which a beauty or spa treatment is to be based.

11. A display device according to claim 6 having a first configuration in which only the colours are displayed and a second configuration in which the word associated with a selected colour is displayed.

12. (canceled)

13. (canceled)

14. A method according to claim 1, wherein the population sample used to select the colours contains 5-40 individuals.

15. A method according to claim 1, wherein step (iii) comprises identifying colours which are associated by at least 60% of the population sample with a word on the list.

16. A display device according to any one of claim 7 comprising a chart on which the colours are displayed, wherein the of display of one or more words associated with each colour comprises a transparent film or sheet adapted to be positioned over the colour chart, and on which at or adjacent to the position of each colour of the chart the associated word is displayed such that when the film is positioned over the chart, both the colour and the associated word may be viewed at the same time.

17. A display device according to claim 6 comprising a set of rods, wherein:
a. all or part of each rod is coloured with a separate colour;
b. on each rod a word associated with the colour of the rod is printed;
wherein the device further comprises concealing the word.

18. A display device according to claim 17 wherein the concealing the word comprises a container in which the rods may be placed such that the words are concealed but the colours are visible

19. A display device according to claim 7 comprising a set of containers, wherein all or part of the outer surface of each container is of a separate colour and wherein the display of one or more words comprises the word associated with a particular colour being concealed within the appropriate container.

20. A display device according to claim 19 wherein the containers comprise separate drawers in a configuration of drawers, wherein all or part of the visible surface of each drawer is a separate colour and wherein a drawer of a chosen colour may be opened to reveal the word associated with that colour.

21. A display device according to claim 19 wherein the containers comprise cavities in a base, wherein each cavity is covered with a coloured lid and wherein the word associated with the colour of the lid is printed on the underside of the lid, inside the cavity or on a sheet of an appropriate material within the cavity.

22. A method for selecting themes for use in a spa or beauty treatment for an individual comprising:
displaying a plurality of colours to the individual;
receiving from the individual a selection of a subset of colours from the plurality of colours; and
displaying, for each of the selected colours in the subset, a word identified as being associated with the selected colour;
wherein the word represents a theme for the treatment; and
wherein the association of a word with a colour may be identified by means-of:
(i) supplying to a population sample a list of words and a set of colour samples;
(ii) requiring each member of the population sample to choose independently a colour from the set of colour samples to be associated with each word in the list; and
(iii) identifying colours which are associated by at least 50% of the population sample with a word on the list.

23. A method according to claim 22, wherein the spa or beauty treatment is a massage, aromatherapy, facials or make-up treatment.

24. A method of selecting themed cosmetic products for an individual, comprising:
displaying a plurality of colours to the individual;
receiving from the individual a selection of a subset of colours from the plurality of colours; and
displaying, for each of the selected colours in the subset, a word associated with the selected colour;
wherein the word represents a theme for the cosmetic products; and
wherein the association of a word with a colour may be determined by means-of:
(i) supplying to a population sample a list of words and a set of colour samples;
(ii) requiring each member of the population sample to choose independently a colour from the set of colour samples to be associated with each word in the list; and
(iii) identifying colours which are associated by at least 50% of the population sample with a word on the list.

25. A method according to claim 24 wherein the cosmetic products are for application to the face, body or hair or bathing products.

26. A method according to claim 22 wherein the subset of colours is selected using a device according to claim 7.

27. (canceled)

28. (canceled)
